(19) United States
(12) Patent Application Publication
(10) Pub. No.: US 2006/0215067 A1
(43) Pub. Date: Sep. 28, 2006

(54) Display device

(75) Inventors: Hiroshi Ueda, Kikuchi-gun (JP); Hirofumi Iwanaga, Chiyoda-ku (JP); Shigeaki Noumi, Chiyoda-ku (JP); Hitoshi Morishita, Chiyoda-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/358,222

(22) Filed: Feb. 22, 2006

(30) Foreign Application Priority Data
Mar. 24, 2005 (JP) 2005-086080

(51) Int. Cl. G02F 1/1343

(52) U.S. Cl. 349/38

(57) ABSTRACT

Yield in mounting a FPC onto an insulating substrate is increased as well as noise is suppressed, thereby the display device having high quality can be obtained.

The display device includes: an insulating substrate on which a display region having pixels is formed; signal wires formed on the insulating substrate and connected to the pixels in the display region; terminals formed, in order to supply signals to the signal wires, outside the display region on the insulating substrate; a driving circuit 3 directly connected to the terminals or a driving circuit connected to the terminals via a film; and a resistor element 9 formed, on the insulating substrate, between adjacent input signal wires 5 for inputting signals to the driving circuit 3.

### BACKGROUND OF THE INVENTION

1. Field of the Invention

The present invention relates to display devices for displaying images by supplying signals to driving circuits connected to the display devices, from external circuit substrates, and is particularly effective in application to liquid crystal displays.

2. Description of the Related Art

A conventional liquid crystal display can display images by connecting a driving circuit to the display in which a liquid crystal is sandwiched between two insulating substrates, and by arranging the display on an illumination device. For example, in an active matrix-type liquid crystal display using thin-film transistors (TFTs), the TFTs are arranged in a matrix on one of the two insulating substrates (or example, glass substrates), and the TFT substrate is stacked onto the other substrate (CF substrate), facing each other, and has a outer shape bigger than that of the CF substrate. A pixel is connected to each of the TFTs, and image signals transmitted to the pixels are controlled by switching the TFTs on/off as switching elements. Source wires for inputting the image signals are pulled out from a source electrode of the each of the TFTs in a nearly parallel direction to a shorter side of the glass substrate, and a terminal for connecting the source electrode to the driving circuit is formed near an end portion of a longer side of the TFT substrate. Moreover, gate wires for switching the TFTs on/off are pulled out from a gate electrode of the each of the TFTs in a nearly parallel direction to a longer side of the TFT substrate, and a terminal for connecting the source electrode to the driving circuit is formed, similarly to the source side wires, near an end portion of a shorter side of the TFT substrate.

When the driving circuit is mounted using, for example, the COG (chip on glass) mounting method, the driving circuit is connected to the terminal, which is arranged near an end portion of the TFT substrate that extends on the TFT substrate, via adhesive in which conductive micro particles are diffused into a resin such as an anisotropic conductive film (ACF), so as be directly mounted on the insulating substrate. Moreover, external connection terminals are formed on end portions of wires that are arranged on the end portion of the TFT substrate near the portion where the driving circuit is mounted on the TFT substrate, and a FPC (flexible printed circuit) is connected to the external connection terminals each through the ACF. A circuit board on which control circuits for controlling the driving circuit are mounted is connected to the FPC, and control signals for the driving circuit are inputted into the driving circuit via wires on the FPC and the TFT substrate. When grey scale signals from the circuit board to the driving circuit are transmitted in a small-amplitude differential signaling format, for example, LVDS (low voltage differential signaling), in order to ensure their amplitude against noise, it is needed that a resistor element is connected between neighboring signal wires, thereby they are shorted each other near the terminating point of the signal wires, in other words, near the input portion of the driving circuit. The small-amplitude differential signaling format has characteristics such as low voltage power, low noise, high-noise-rejection performance, and high-reliability in signal transmission, which therefore has recently been increasingly adopted in many liquid crystal displays. Terminating resistors used in the small-amplitude differential signaling format, have been conventionally formed by mounting the resistor elements near the input portion of the driving circuit on the FPC.

Moreover, in the conventional liquid crystal display, a capacitor element (bypass condenser) is formed, in order to prevent electromagnetic noise from occurring, between wires for inputting power and the ground potential to the driving circuit, near the input portions of the wires to the driving circuit on the FPC.

In addition, in the conventional liquid crystal display, flexibility of pattern design for the driving circuit has been increased and miniaturization of the whole liquid crystal display has been made possible, by forming on the insulating substrate at least part of the resistor elements of the driving circuit, as a method of forming passive elements such as a resistor element (for example, refer to Patent Document 1).

Patent Document 1:

Japanese Laid-Open Open Patent Publications 1994-250198 (FIG. 1)

### SUMMARY OF THE INVENTION

Problems to be Solved by the Invention:

In a conventional display device as described above, because a resistor element or a capacitor element, as a terminator, is formed on a FPC, there have been problems in that surface mounting process is required only to mount the resistor element or the capacitor element in manufacturing processes for the FPC, which has caused cost increase of the display device.

Moreover, there have been also problems in that yield ratio of mounting the FPC onto a TFT substrate is decreased in the surface mounting process due to deformation of the FPC by heat, because the FPC is exposed to a high-temperature environment during soldering in the surface-mounting process.

Moreover, although it is not explained to connect a resistor element or a capacitor element across signal wires for inputting signals to the driving circuit directly mounted on the insulating substrate, or across power and the ground potential, there have been problems in that the same trouble as described above occurs, when the resistor element or the capacitor element is surface-mounted on the FPC.

An objective of the present invention that has been made in order to solve the above problems is to provide a display device in which yield ratio of mounting the FPC onto a TFT substrate is increased as well as noise is suppressed, so that high displaying quality is ensured.

Means for Solving the Problems:

A display device according to the present invention includes: an insulating substrate on which a display region having pixels is formed; signal wires formed on the insulating substrate and connected to the pixels in the display region; terminals formed, in order to supply signals to the signal wires, on the insulating substrate outside the display region; a driving circuit directly connected to the terminals; and a resistor element formed on the insulating substrate, between adjacent ones of input wires for inputting signals to the driving circuit.

According to the present invention, yield ratio of mounting the FPC on a TFT substrate is increased as well as noise is suppressed, thereby a display device having high quality can be obtained.

### BRIEF DESCRIPTION OF THE DRAWINGS

FIG. 1 is a schematic diagram illustrating a display device according to Embodiment 1 of the invention;

FIG. 2 is an enlarged view illustrating a portion where a resistor element in FIG. 1 is formed between input wires;

FIG. 3 is another enlarged view illustrating another portion where the resistor element in FIG. 1 is formed between the input wires;

FIG. 4 is a cross-sectional view along the line “A-A” illustrated in FIG. 3;

FIG. 5 is an enlarged view illustrating input wires to a driving circuit according to Embodiment 2 of the invention; and

FIG. 6 is a cross-sectional view along the line “B-B” illustrated in FIG. 5.

### DESCRIPTION OF THE SYMBOLS

“1” is an insulating substrate, “2” is a facing substrate, “3” are driving circuits, “4” are output wires, “5” are input wires, “6” is a FPC, “7” are external connection terminals, “8” are wires on the FPC, “9” is a resistor element, “10” is a first metal film 10, “11” is an insulating film, “12” are contact holes, “13” is a second metal film, and “14” is a capacitor element.

### DETAILED DESCRIPTION OF THE PREFERRED EMBODIMENTS

### Embodiment 1

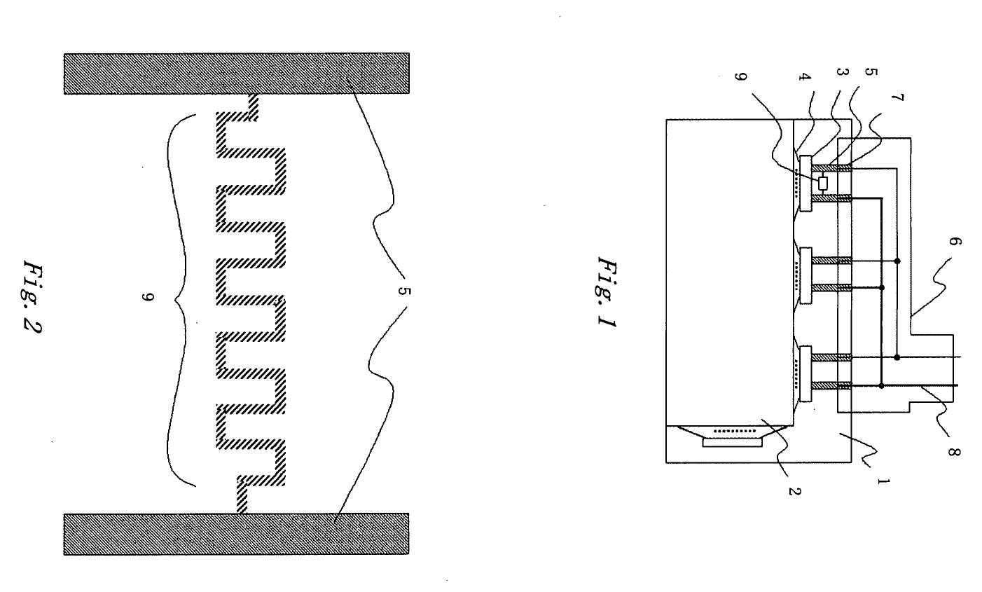

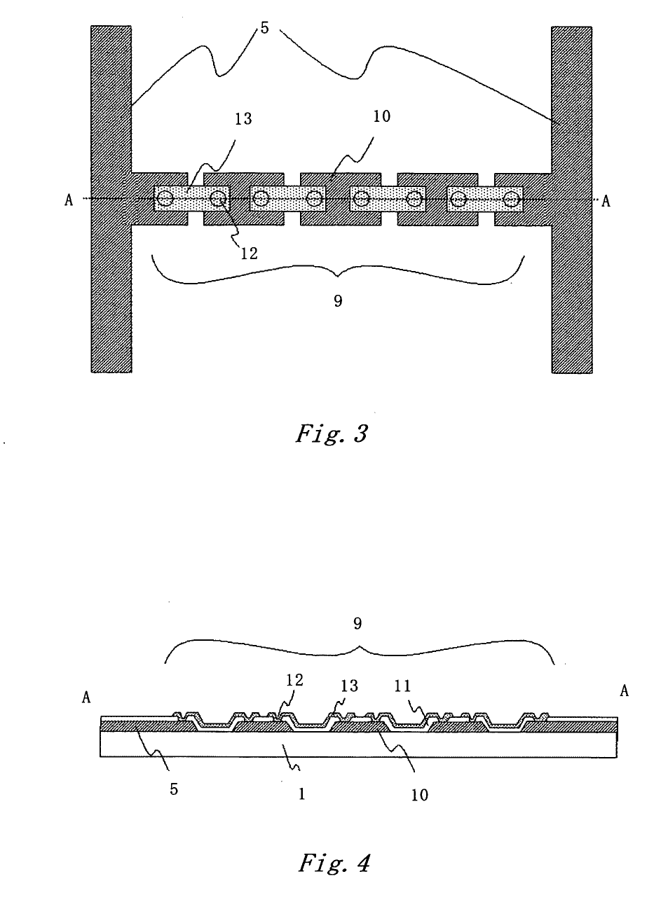

Embodiment 1 of the present invention is explained according to FIG. 1 through FIG. 4. FIG. 1 is a schematic diagram illustrating a display device according to Embodiment 1 of the invention, FIG. 2 is an enlarged view illustrating a portion where a resistor element in FIG. 1 is formed, FIG. 3 is another enlarged view illustrating another portion where the resistor element in FIG. 1 is formed, and FIG. 4 is a cross-sectional view along the line “A-A” illustrated in FIG. 3.

In FIG. 1, an insulating substrate “1” and a facing substrate (CF substrate) “2” facing the substrate 1 are glued with each other, and a driving circuit “3” is mounted on a portion on the insulating substrate 1 extending from the facing substrate 2. Embodiment 1 represents a case where the driving circuit 3 is directly mounted on terminals formed on the insulating substrate 1, by using a flip-chip mounting method, so-called a COG method. Display signals and the like are outputted to pixels in a display region from the driving circuit 3, which is connected to the pixels through output wires “4” formed on the insulating substrate 1. In addition, signals, power, and the ground potential are inputted from input wires “5” to the driving circuit 3 through the terminals formed on the insulating substrate 1. On an end portion of the insulating substrate 1, which is the opposite end of the input wires 5 whose one end is connected to the driving circuit 3 of the input wires 5, an external connection terminal “7” is formed for connection to a FPC “6” connected to an outside circuit board (not illustrated). The various signals, power, and the ground potential are supplied, from the outside circuit board on which control circuits are mounted, to the insulating substrate 1 through wires “8” on the FPC 6. When grey-scale signals, as display signals to a display device, are transmitted in a small-amplitude differential signaling format, for example, an LVDS format, it is needed that the signal wires be shorted by connecting a resistor element across the wires near the above-described terminals of the wires, in other words, near the input portion to the driving circuit, therefore, a resistor element “9” is formed, on the insulating substrate 1, between adjacent input wires for inputting signals to the driving circuit.

FIG. 2 is an enlarged view illustrating a portion where the resistor element 9 is formed between the input wires in FIG. 1, and the resistor element 9 is formed between the input wires 5 connected to the driving circuit by forming a rectangularly serpentine pattern as illustrated in FIG. 2, at the same time as, for example, forming a transparent conducting film that composes the pixels in the display region. It is desirable that the resistor element 9 be formed in a position as near to the driving circuit as possible.

Moreover, the rectangularly serpentine pattern formed of the transparent conducting film may be connected to the input wires via contact holes formed through an insulating film, or may be directly connected to the input wires without going through the contact holes. Moreover, although it is desirable that the resistance value of the resistor element be roughly 100 ohms, the resistance value can be adjusted by varying the thickness or the length of the pattern, or by varying the shape of the rectangularly serpentine pattern. In the above explanation, although a transparent conducting film is used as the conducting film forming rectangularly the serpentine pattern, another conducting film or a semiconductor film can be used for realizing a predetermined resistance value by considering the thickness and the length of the pattern, or the shape of rectangularly the serpentine pattern. In this case, the resistor element can be formed, without increasing manufacturing processes, because a conducting film is formed on the same layer as that composing each of the signal wires.

FIG. 3 is another enlarged view illustrating a portion where the resistor element 9 is formed between the input wires in FIG. 1, and FIG. 4 is a cross-sectional view along the line “A-A” illustrated in FIG. 3. As illustrated in FIG. 3 and FIG. 4, an insulating film “11” is formed on a first metal film “10” that is formed of, for example, the conducting film in the same layer as the input wires 5, and after contact holes “12” have been formed through the insulating film 11, a second metal film “13” is formed. By structuring described above, the first metal film 10 is connected with the second metal film 13 via the contact holes 12, and the resistor element 9 is formed between the input wires 5. Moreover, in FIG. 3 and FIG. 4, because the resistor element is formed by connecting the two different layered metal films with each other using the contact holes formed through the insulating film, resistance values at portions where the two layered metal films are contacted with each other are increased, and a resistor element having a high resistance value (for example, roughly 100 ohms) can be easily formed.

Here, a resistor at the portions where the two layered metal films are contacted with each other is referred to as a contact resistor in this specification. Moreover, although materials of the first metal film and the second metal film are not particularly limited, a resistor element having a higher resistance value can be obtained by forming either one of the two metal films at the same time as forming the transparent conducting film composing the pixels as described above. In FIG. 3 and FIG. 4, although the resistor element is illustrated as formed by connecting the two different layered metal films with each other using the contact holes formed through the insulating film, the two different layered metal films may be directly connected without using the contact holes. In addition, the resister may be formed by connecting not less than three different layered metal films with each other. Moreover, it is desirable that the resistor element 9 be formed in a position as near to the driving circuit as possible, similar to the case described above.

Because the resistor element is formed by structuring described above, a resistor element having a high resistance value can be easily formed, on the insulating substrate, between adjacent input signal wires for inputting signals to the driving circuit, not only cost of a surface-mounting process of the FPC is not increased, but also it is possible to prevent yield reduction in mounting the FPC onto the TFT substrate, due to heat deformation caused by surface-mounting on the FPC, therefore, a display device having high reliability and quality can be obtained.

### Embodiment 2

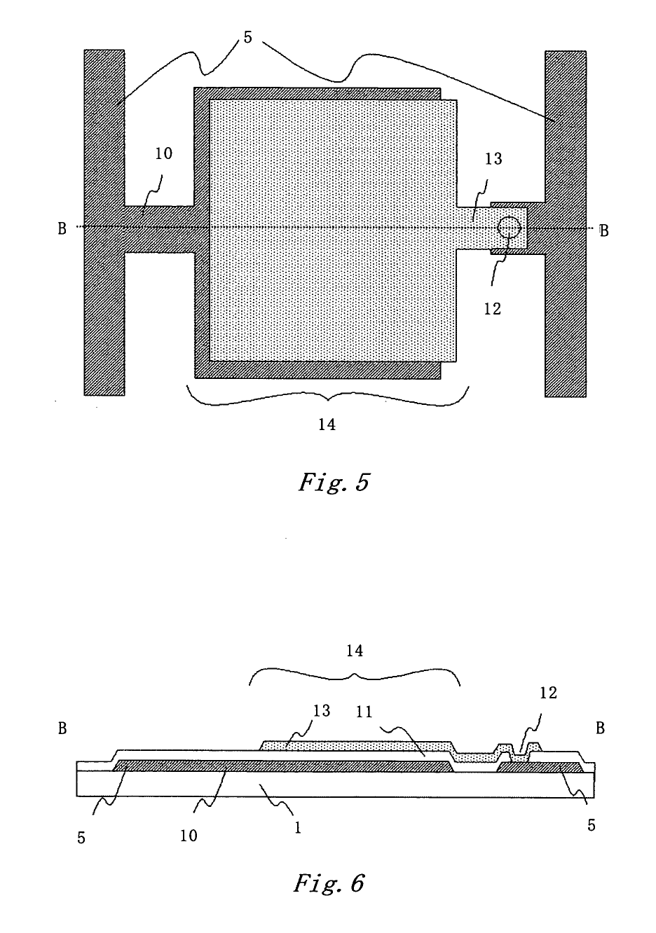

Embodiment 2 of the present invention is explained according to FIG. 5 and FIG. 6. FIG. 5 is an enlarged view illustrating an input wire portion to the driving circuit in FIG. 1, and FIG. 6 is a cross-sectional view along the line “B-B” illustrated in FIG. 5. In FIG. 5 and FIG. 6, the components that are the same as those in FIG. 1 through FIG. 4 are given the same symbols, and only differing components will be explained.

In Embodiment 2, a capacitor element “14”, instead of the resistor element, is formed at the input wire portion to the driving circuit in FIG. 1. When it is required to form a capacitor element, the capacitor element (bypass condenser) is formed between adjacent input wires, as the input wires 5, of power and the ground potential, in order to prevent electromagnetic noise from generating. In FIG. 5 and FIG. 6, the capacitor element 14 is composed of the first metal film 10 formed of the same conducting film as the input wires 5, the insulating film 11 formed on the first metal film 10, and the second metal film 13 formed on the insulating film 11. In addition, the input wires 5 is connected to the second metal film 13 via the contact holes 12 formed through the insulating film 11. Moreover, it is desirable that the capacitor element 14 be formed in a position as near to the driving circuit as possible.

Because the structure described above enables the capacitor element to be formed, on the insulating substrate, between adjacent input wires of the power and the ground potential to the driving circuit, and noise to be suppressed, a display device having high quality can be obtained.

The display device described in Embodiment 1 and Embodiment 2 can be a display device using a liquid crystal or an electroluminescence (EL) element, and the structure can be applied to various display devices, in which their driving circuit is mounted on the substrate thereof, and to which signals, power, and the ground potential are inputted.

What is claimed is:

1. A display device, comprising:
an insulating substrate on which a display region having pixels is formed;
signal wires formed on the insulating substrate and connected to the pixels in the display region;
a terminal formed, in order to supply signals to the signal wires, on the insulating substrate outside the display region;
a driving circuit directly connected to the terminal; and
a resistor element formed on the insulating substrate, between adjacent ones of input wires for inputting signals to the driving circuit.

2. A display device as recited in claim 1, wherein the resistor element is composed of a conducting film formed on the same layer as a conducting film composing the signal wires, of a transparent conducting film composing the pixels forming the display region, or of a semiconductor film.

3. A display device as recited in claim 1, wherein the resistor element is composed of at least two different layered metal films.

4. A display device, comprising:
an insulating substrate on which a display region having pixels is formed;
signal wires formed on the insulating substrate and connected to the pixels in the display region;
a terminal formed, in order to supply signals to the signal wires, on the insulating substrate outside the display region;
a driving circuit directly connected to the terminal; and
a capacitor element formed on the insulating substrate, between adjacent ones of input wires for inputting power and ground potential to the driving circuit.

5. A display device as recited in claim 4, wherein the capacitor element is composed of an insulating film disposed between two different layered metal films.
